(19) United States
(12) Patent Application Publication
(10) Pub. No.: US 2004/0216277 A1
(43) Pub. Date: Nov. 4, 2004

(54) Hinge and locking assembly for center-folding ladder

(76) Inventor: Jeffrey Beaver, Indianapolis, IN (US)

Correspondence Address: BARNES & THORNBURG, 11 SOUTH MERIDIAN, INDIANAPOLIS, IN, 46204

(21) Appl. No.: 10/809,723

(22) Filed: Mar. 25, 2004

Related U.S. Application Data
(60) Provisional application No. 60/467,220, filed on May 1, 2003.

(51) Int. Cl. E05D 11/10

(52) U.S. Cl. 16/324

(57) ABSTRACT

A locking hinge apparatus includes first and second hinge members coupled together for rotation about an axis, a lock movable between a locking position in which the first and second hinge members are prevented from rotating about the axis and a releasing position in which the first and second hinge members are permitted to rotate about the axis, and a knob rotatable about the axis and movable along the axis. The lock moves from the locking position to the releasing position in response to movement of the knob axially toward the first and second hinge members and then rotation of the knob about the axis.

This application claims priority under 35 U.S.C. § 119(e) to U.S. Provisional Application Ser. No. 60/467,220, filed May 1, 2003, which is expressly incorporated by reference herein.

### BACKGROUND

The present disclosure relates to a center-folding ladder, and more particularly to a hinge and locking assembly for a center-folding ladder.

Ladders are commonly used for a variety of applications and are of two general types. One type is a center-folding ladder, commonly called a step ladder, which is self-supporting. Step ladders are typically used for such tasks as pruning, painting ceilings, or other similar tasks where it is difficult or inconvenient to lean the ladder against a structure, such as a wall, for support. The other type of ladder is the straight extension ladder. This type of ladder is simply leaned against the wall or some other structure when standing or climbing on the ladder.

Ladders which are constructed so that they may be used as both step ladders and as straight extension ladders have been known in the art. Such ladders, commonly referred to as combination step and extension ladders, are very versatile and they combine the desirable features of both types of ladders. Such combination ladders typically include a hinge and locking assembly at each end. The hinge and locking assemblies permit the ladder to be folded into and locked in a step ladder configuration or unfolded into and locked in a straight extension ladder configuration. Examples of combination ladders are U.S. Pat. Nos. 3,912,043; 4,566,150; and 4,770,559 which are incorporated herein by reference.

### SUMMARY

One or more of the following features or elements or combinations thereof may be incorporated into a hinge and a locking assembly.

A hinge and locking assembly is provided. Such an assembly may be used, for example, to couple sections of a center-folding ladder. It will be appreciated that such an assembly may have various uses. Such a hinge and locking assembly permits the ladder to be folded into and locked in a step ladder configuration or unfolded into and locked in an extension ladder configuration. The hinge and locking assembly does not lock the ladder as the ladder passes through the step ladder configuration during movement of the ladder from the extension ladder configuration to the collapsed configuration.

The assembly comprises a pair of support plates, a locking bar and a lifting cam. The support plates are rotatable relative to each other about a common axis. Each plate has at least one locking slot. The locking bar has at least one locking tab configured to engage the locking slots in the support plates to block relative movement of the support plates relative to each other. The lifting cam is configured to move the locking bar relative to the support plates to selectively disengage the locking tab from the locking slots in the support plates to permit relative movement of the support plates relative to each other.

The assembly includes a drive shaft rotatable about the common axis and the lifting cam is coupled to drive shaft for rotation therewith. The locking bar is coupled to the drive shaft for axial movement relative to the support plates. The locking bar has a pair of axially-extending locking tabs which are spaced at equal radial distances from the common axis on the opposite sides thereof along a line that extends through the common axis.

A first one of the support plates has a pair of locking slots. The locking slots may be axially extending. The locking slots may be radially extending. The locking slots may be peripherally or circumferentially-spaced. The locking slots may be spaced at equal radial distances from the common axis on the opposite sides of the common axis along a line that extends through the common axis. Each locking slot may be circular, rectangular, square, or any other suitable shape.

A second one of the support plates has a first pair of locking slots so that the locking tabs of the locking bar can extend through the pair of locking slots in the first support plate and the first pair of locking slots in the second support plate in a first configuration of the support plates. The first pair of locking slots may be axially extending. The first pair of locking slots may be radially extending. The first pair of locking slots may be peripherally or circumferentially-spaced. The first pair of locking slots may be spaced at equal radial distances from the common axis on the opposite sides of the common axis along a line that extends through the common axis. Each of the first pair of locking slots may be circular, rectangular, square, or any other suitable shape.

The second support plate has a second pair of locking slots so that the locking tabs of the locking bar can extend through the pair of locking slots in the first support plate and the second pair of locking slots in the second support plate in a second configuration of the support plates. The second pair of locking slots may be axially extending. The second pair of locking slots may be radially extending. The second pair of locking slots may be peripherally or circumferentially-spaced. The second pair of locking slots may be spaced at equal radial distances from the common axis on the opposite sides of the common axis along a line that extends through the common axis. Each of the second pair of locking slots may be circular, rectangular, square, or any other suitable shape.

The first and second pairs of axially-extending locking slots in the second support plate are arranged to form an acute angle relative to each other. The assembly includes a spring for biasing the locking bar toward the support plates so that the locking tabs extend through the locking slots in the support plates to block relative movement of the support plates relative to each other.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a center-folding ladder having at each end a pair of legs coupled together by a hinge and locking assembly in accordance with this disclosure which permit the ladder to be folded into and locked in a step ladder configuration or unfolded into and locked in a straight extension ladder configuration,

FIGS. 2-4 are end views showing the ladder moving from a collapsed configuration in FIG. 2 (also referred to as a 0° configuration), to a step ladder configuration in FIG. 3 (also referred to as a folded or 40° configuration) and then to a straight extension ladder configuration in FIG. 4 (also referred to as a fully open or 180° configuration),

FIGS. 5-7 are end views similar to FIGS. 2-4 showing the ladder moving from the extension ladder configuration in FIG. 5 to the collapsed configuration in FIG. 7 through an intermediate configuration in FIG. 6,

FIG. 8 is an exploded perspective view of various components that can be assembled to produce the hinge and locking assembly in accordance with this disclosure, and showing, from left to right, front outer covers, locking bar support pin, locking bar, snap spring, knob support pin, drive shaft (also referred to as cam drive shaft), tri-lobe lifting cam, front support plate, rear support plate, locking plate, detent plate (also referred to as unidirectional spring), spring clip, knob spring, winged hex drive, lock washer, rear outer covers, and knob,

FIG. 9 is a sectional view of the hinge and locking assembly in the collapsed configuration of the ladder in FIG. 2 (and corresponding to a line 9-9 in FIG. 8), and showing the locking bar moved to a lowered locked position (also referred to as advanced locked position) and further showing the knob in a released position, where the tabs of the locking bar pass through a pair of aligned tab-receiving slots in each of the front and rear support plates to lock the ladder in the collapsed configuration,

FIG. 10 is a sectional view similar to FIG. 9 showing the knob pushed inward to cause the winged hex drive to engage the cam drive shaft,

FIG. 11 is a sectional view similar to FIG. 10 showing the knob pushed inward and rotated 60° (corresponding to the dotted position of the knob in FIG. 2) to cause the lifting cam to move the locking bar to a raised unlocked position (also referred to as retracted unlocked position), where the tabs of the locking bar are retracted from the tab-receiving slots in the rear support plate to allow the ladder to move to either the step ladder configuration shown in FIG. 3 or the extension ladder configuration in FIG. 4,

FIG. 12 is a sectional view similar to FIG. 11 showing the knob in the released position causing the winged hex drive to disengage from the drive shaft and showing the ladder moved to the 120° configuration in FIG. 6, where the locking bar is off the lobes of the lifting cam and the tabs of the locking bar ride on the front surface of the rear support plate,

FIGS. 13-15 show the relative positions of the locking bar and the lifting cam as the ladder moves from the collapsed configuration to the step ladder configuration,

FIGS. 16 and 17 show the relative positions of the locking bar and the lifting cam as the ladder moves back from the step ladder configuration to the collapsed configuration,

FIGS. 18-20 show the relative positions of the locking bar and the lifting cam as the ladder moves from the step ladder configuration to the straight extension ladder configuration,

FIGS. 21-23 show the relative positions of the locking bar and the lifting cam as the ladder moves back from the straight extension ladder configuration to the collapsed configuration,

FIG. 24 is a perspective view of the locking bar,

FIG. 25 is a perspective view of the drive hub,

FIG. 26 is an end view of the drive hub viewing from the end of the assembly opposite from the locking bar,

FIG. 27 is a sectional view of the drive hub along a line 27-27 in FIG. 26,

FIG. 28 is a perspective view of the lifting cam,

FIG. 29 is a perspective view of the locking bar support pin,

FIG. 30 is a perspective view of the knob support pin,

FIG. 31 is a perspective view of the U-shaped snap spring,

FIG. 32 is a side view of the snap spring,

FIG. 33 is a perspective view of the locking plate,

FIG. 34 is a side view of the locking plate,

FIG. 35 is a perspective view of the detent plate,

FIG. 36 is an elevational view of the detent plate,

FIG. 37 is a perspective view of the knob,

FIG. 38 is a side view of the knob, and

FIG. 39 is an elevational view of the rear support plate.

### DETAILED DESCRIPTION

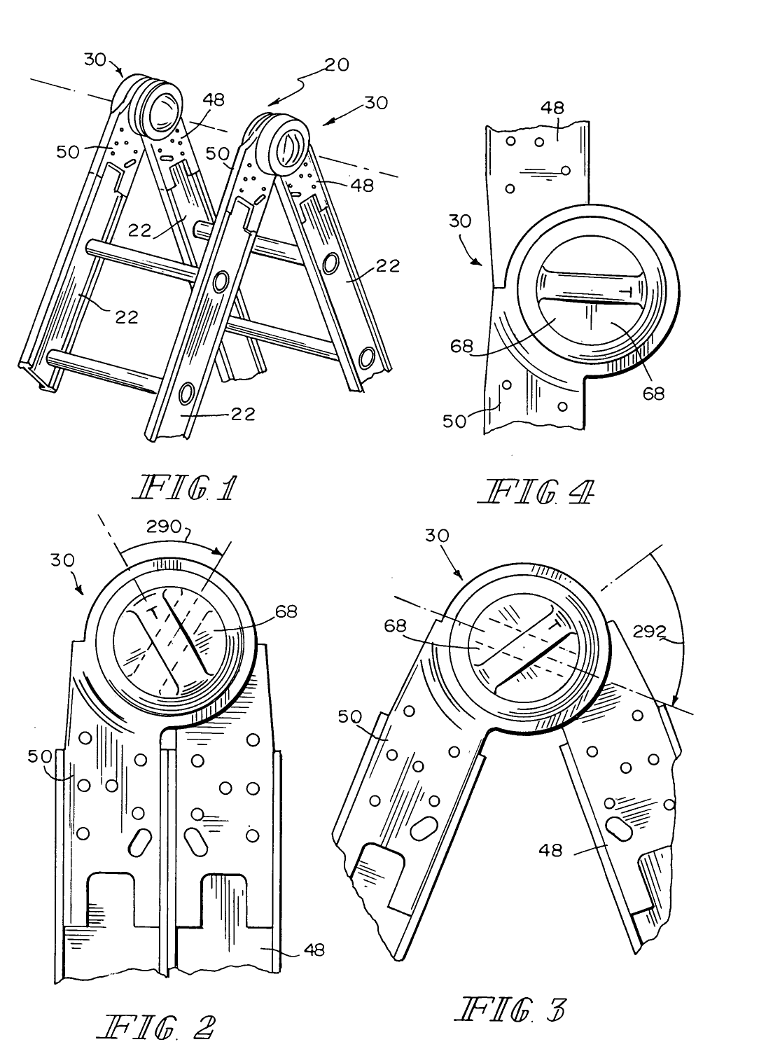

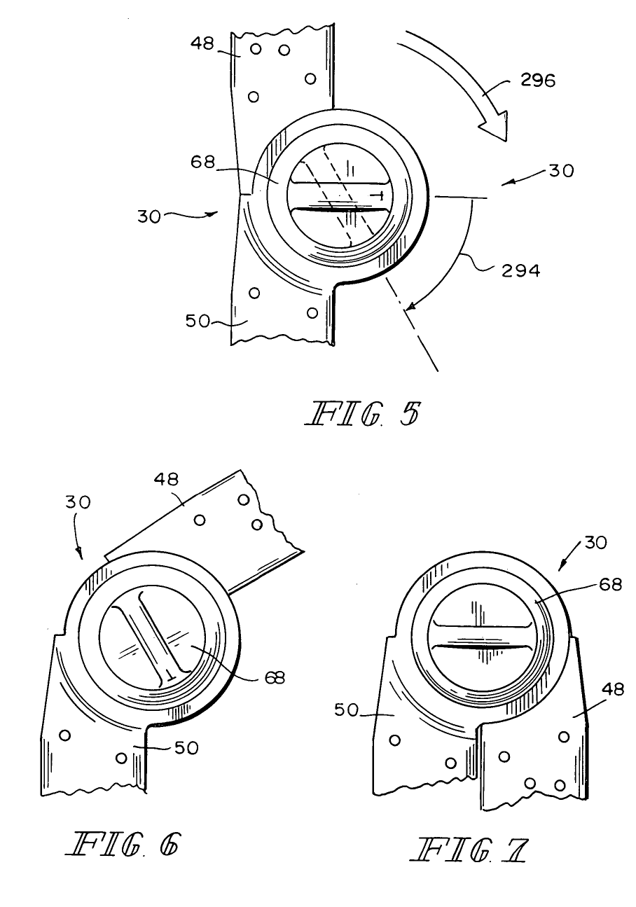

A perspective view of a center-folding ladder 20 having at each end a pair of legs 22 coupled together by a hinge and locking assembly 30 is shown in FIG. 1. The hinge and locking assembly 30 at each end permits the ladder 20 to be folded into and locked in a step ladder configuration shown in FIG. 3 or unfolded into and locked in an extension ladder configuration as shown in FIG. 4. To move the ladder 20 from the collapsed configuration in FIG. 2 to the step ladder configuration shown in FIG. 3, each knob 68 is pushed inward and rotated 60° clockwise (identified by numeral 290 in FIG. 2) to unlatch the hinge and locking assemblies 30 and the legs 22 are then spread apart. The rotated position of the knob 68 is shown by the dotted lines in FIG. 2. When the legs 22 move to the step ladder configuration shown in FIG. 3, the hinge and locking assemblies 30 automatically latch to securely lock the legs 22 in the step ladder configuration.

To move the ladder 20 from the step ladder configuration in FIG. 3 to the extension ladder configuration shown in FIG. 4, each knob 68 is again pushed inward and rotated 60° clockwise (identified by numeral 292 in FIG. 3) to unlatch the hinge and locking assemblies 30 and the legs 22 are then moved to the fully open position. The rotated position of the knob 68 is shown by the dotted lines in FIG. 3. When the legs 22 move to the extension ladder configuration shown in FIG. 4, the hinge and locking assemblies 30 automatically latch to securely lock the legs 22 in the extension ladder configuration.

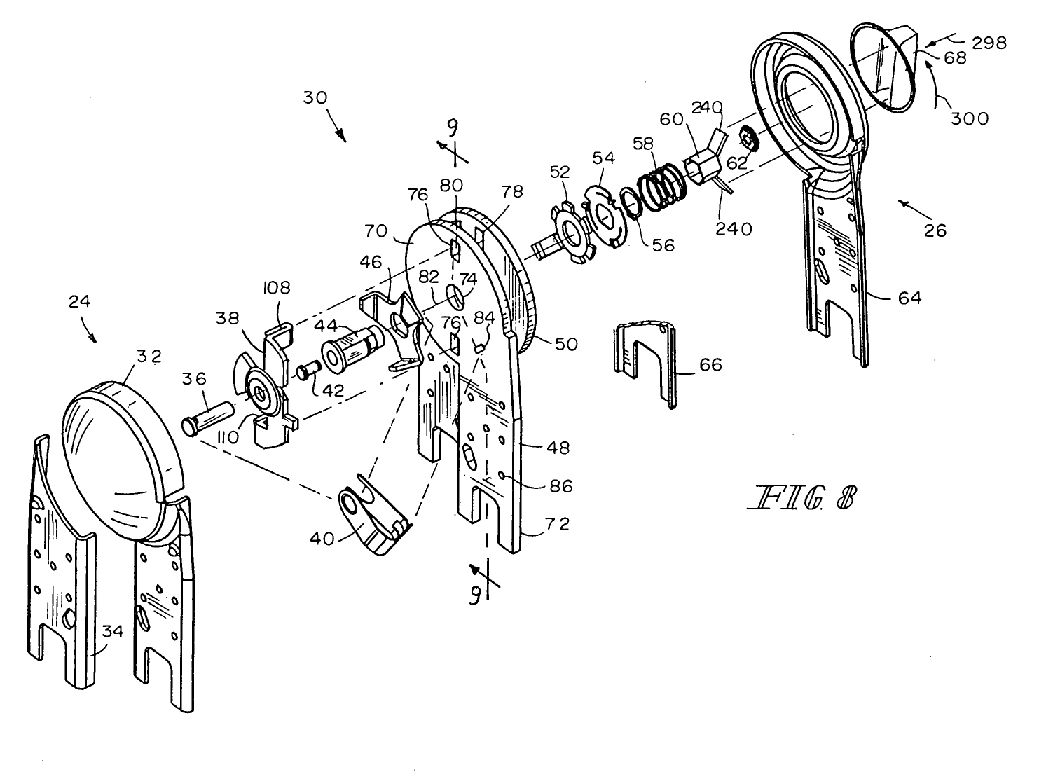

To move the ladder 20 from the extension ladder configuration in FIG. 5 to the collapsed configuration shown in FIG. 7, each knob 68 is again pushed inward and rotated 60° clockwise (identified by numeral 294 in FIG. 5) to unlatch the hinge and locking assemblies 30 and the legs 22 are brought together as shown in FIGS. 6 and 7. The rotated position of the knob 68 is shown by the dotted lines in FIG. 5, and the direction of rotation is shown therein by numeral 296. When the legs 22 move to the collapsed configuration shown in FIG. 7, the hinge and locking assemblies 30 automatically latch to lock the legs 22 securely in the collapsed configuration. The hinge and locking assemblies 30 do not lock the ladder as the ladder 20 passes through the step ladder configuration during movement of the ladder 20 from the extension ladder configuration in FIG. 5 to the collapsed configuration in FIG. 7.

As shown in FIG. 8, each hinge and locking assembly 30 includes, from left to right, front outer covers 32, 34, a locking bar support pin 36, a locking bar 38, a U-shaped snap spring 40 (also referred to as the formed spring), a knob support pin 42, a drive shaft 44 (also referred to as the cam shaft), a tri-lobe lifting cam 46, a front support plate 48, a rear support plate 50, a locking plate 52, a detent plate 54, a spring clip 56, a knob spring 58, a winged hex drive 60, a lock washer 62, rear outer covers 64, 66, and a lock release knob 68. In this disclosure, the terms “front”, “raised”, “advanced”, “upward”, “forward” and “head end” all mean toward the end 24 of the assembly 30 having the locking bar 38 and the lifting cam 46. On the other hand, the terms “back”, “lowered”, “retracted”, “backward”, “downward”, “rear” and “foot end” mean toward the end 26 of the assembly 30 opposite from the locking bar 38 and the lifting cam 46. Unless specified otherwise, all rotational directions (clockwise or anticlockwise) are referenced from the end 26 of the assembly 30 having the knob 68. Also, the terms “slot”, “hole”, “opening”, “aperture”, etc. are synonymous in this disclosure.

Referring to FIG. 39, each support plate 48, 50 includes an annular head portion 70 and a leg-engaging portion 72. The leg-engaging portion 72 may be so oriented with respect to the annular head portion 70 that the outer edge of the leg-engaging portion 72 extends generally tangentially from the annular head portion 70 as shown in FIG. 39. The leg-engaging portions 72 are secured to the respective legs 22 of the ladder 20 by suitable fasteners, such as screws or nuts and bolts. Although each support plate 48, 50 comprises a single plate in the illustrative embodiment shown, each support plate 48, 50 may very well be made of a plurality of individual plates (for example, 2 or 4) which are joined together as a unit by suitable fasteners.

The two support plates 48, 50 are identical with one exception which is explained below. Each support plate 48, 50 has a bore 74 at the center of the annular portion 70 for rotatably receiving the cam drive shaft 44. The front support plate 48 has one set of locking tab-receiving slots 76. The rear support plate 50, on the other hand, has 2 sets of locking tab-receiving slots 78, 80 which are 40° apart as shown in FIG. 39. The tab-receiving slots 76, 78, 80 are spaced at equal radial distances from a longitudinal axis 82 (shown in FIG. 8, and sometimes referred to as the common axis) of the assembly 30 on the opposite sides of the central bore 74 along a line that extends through the longitudinal axis 82.

Although the front support plate 48 has one set of locking tab-receiving slots 76 in the illustrative embodiment, the front support plate may very well have two sets of locking tab-receiving slots. Also, although the two sets of tab-receiving slots 78, 80 in the rear support plate 50 are 40° apart in the illustrative embodiment, they may very well be arranged to lie at a different angle with respect to each other, for example 35° or 60°. Each support plate 48, 50 has a positioning tab-receiving hole 84, and a plurality of apertures 86 for rigidly securing the hinge assembly 30 to the legs 22 of the ladder 20.

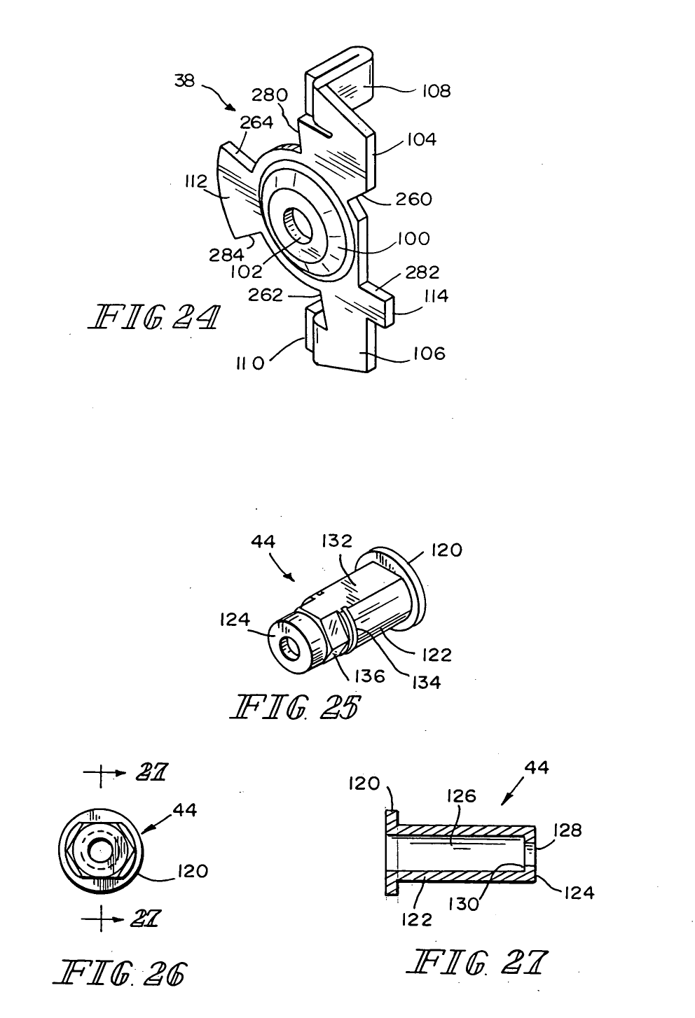

As shown in FIG. 24, the locking bar 38 includes a dome-shaped annular portion 100 having a central bore 102 sized to permit slidable movement of the locking bar support pin 36 and a pair of straight portions 104, 106 which extends generally outwardly from the annular portion 100 on the opposite sides thereof. The terminal portion of each straight portion 104, 106 is formed to include a downwardly-extending locking tab 108, 110 which extends perpendicularly from the plane of the lifting bar 38 as shown. The locking bar 38 includes a truncated pie-shaped portion 112 on one side thereof and tab 114 on the other side thereof as shown.

The locking tabs 108, 110 are spaced at equal radial distances from the longitudinal axis 82 (see FIG. 8) of the assembly 30 on the opposite sides of the central bore 102 along a line that extends through the longitudinal axis 82. As shown in FIG. 24, the straight portions 104, 106 extend in a direction that is generally parallel to the line extending through the downwardly-extending locking tabs 108, 110. The locking tabs 108, 110 are configured to be received in the tab-receiving slots 76 in the front support plate 48 and the tab-receiving slots 78 in the rear support plate 50 when the ladder 20 is either in the collapsed or 0° configuration shown in FIG. 2 or in the extension ladder or 180° configuration shown in FIG. 4. On the other hand, the locking tabs 108, 110 are configured to be received in the tab-receiving slots 76 in the front support plate 48 and the tab-receiving slots 80 in the rear support plate 50 when the ladder 20 is in the step ladder configuration shown in FIG. 3.

Thus, the locking tabs 108, 110 are configured to always extend through the tab-receiving slots 76 in the front support plate 48. However, the locking tabs 108, 110 are configured to extend through the first set of tab-receiving slots 78 in the rear support plate 50 when the ladder 20 is either in the collapsed or 0° configuration shown in FIG. 2 or in the extension ladder or 180° configuration shown in FIG. 4. On the other hand, the locking tabs 108, 110 are configured to extend through the second set of tab-receiving slots 80 in the rear support plate 50 when the ladder 20 is in the step ladder configuration shown in FIG. 3.

Referring to FIGS. 25-27, the drive shaft 44 includes a head portion 120, a longitudinally-extending cylindrical body portion 122 and an annular portion 124. The drive shaft 44 includes a first longitudinally-extending bore 126 that extends through the head and body portions 120, 122 and a second longitudinally-extending counterbore 128 that extends through the annular portion 124. The first bore 126 is sized to permit slidable movement of the locking bar support pin 36. The second counterbore 128 is sized to permit slidable movement of the knob support pin 42. The first and second bores 126, 128 intersect at a shoulder or seat portion 130. The outer surface of the body portion 122 includes a double-D portion 132 having a locking groove 134 formed therein to receive the spring clip 56 and a hex drive portion 136.

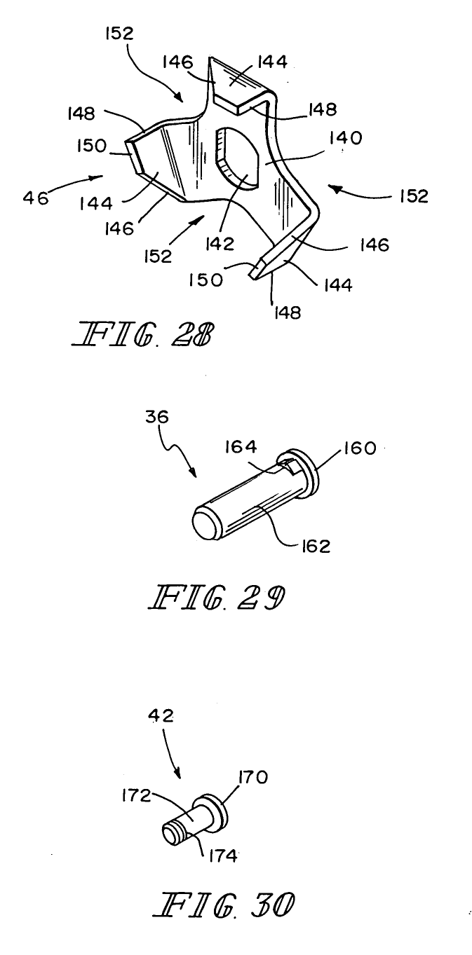

As shown in FIG. 28, the lifting cam 46 includes an annular portion 140 having a double-D bore 142 at the center of the annular portion 140 for receiving the double-D portion 132 of the drive shaft 44 so that the drive shaft 44 and the lifting cam 46 are rotatably coupled to each other. The lifting cam 46 includes three upwardly-extending lobes 144 which extend perpendicularly from the plane of the lifting cam 46 and which are spaced 120° apart as shown. Each lobe 144 a leading inclined portion 146, a trailing perpendicular portion 148, and a raised locking bar-supporting portion 150 arranged to interconnect the inclined portion 146 with the perpendicular portion 148.

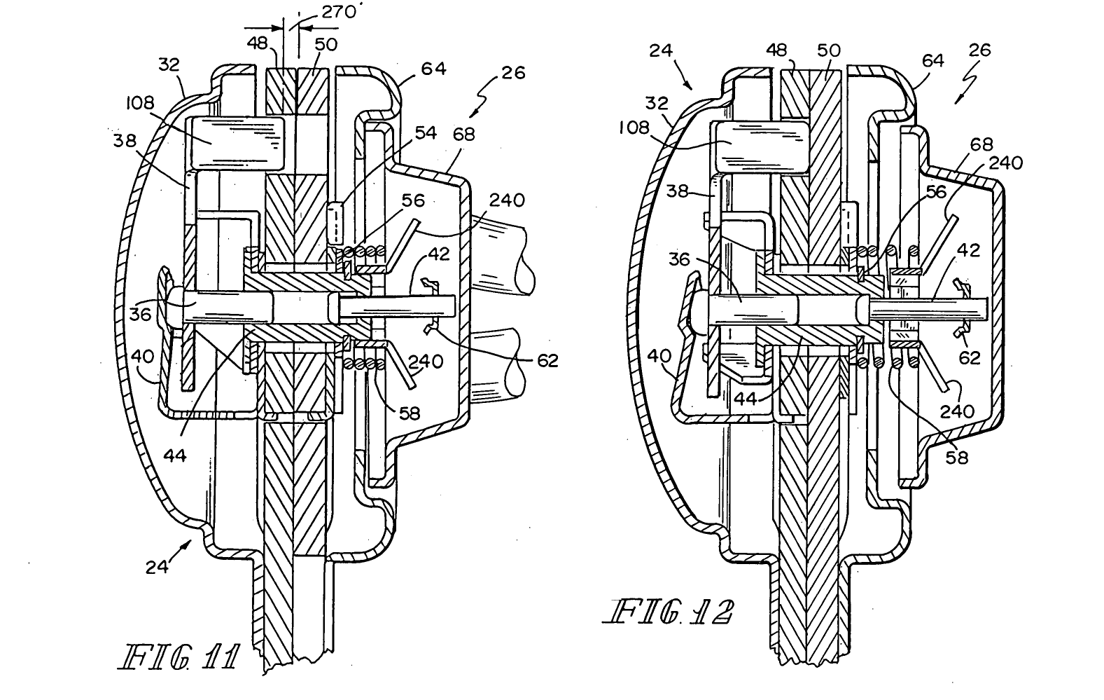

Referring to FIG. 29, the locking bar support pin 36 includes a head portion 160 and a longitudinally-extending body portion 162 having a raised portion 164 where the head and body portions 160, 162 meet. The raised portion 164 of the locking bar support pin 36 provides an interference fit with the bore 102 in the locking bar 38 to secure the locking bar support pin 36 to the locking bar 38. Although the locking tabs 108, 110 always remain extended into the slots 76 in the front support plate 48 as shown, for example, in FIG. 11, the locking bar support pin 36 provides additional stabilization to the locking bar 38 as the locking bar 38 is lifted and lowered by the lifting cam 46. As shown in FIG. 30, the knob support pin 36 includes a head portion 170 and a longitudinally-extending body portion 172 having a locking groove 174 adapted to receive the lock washer 62.

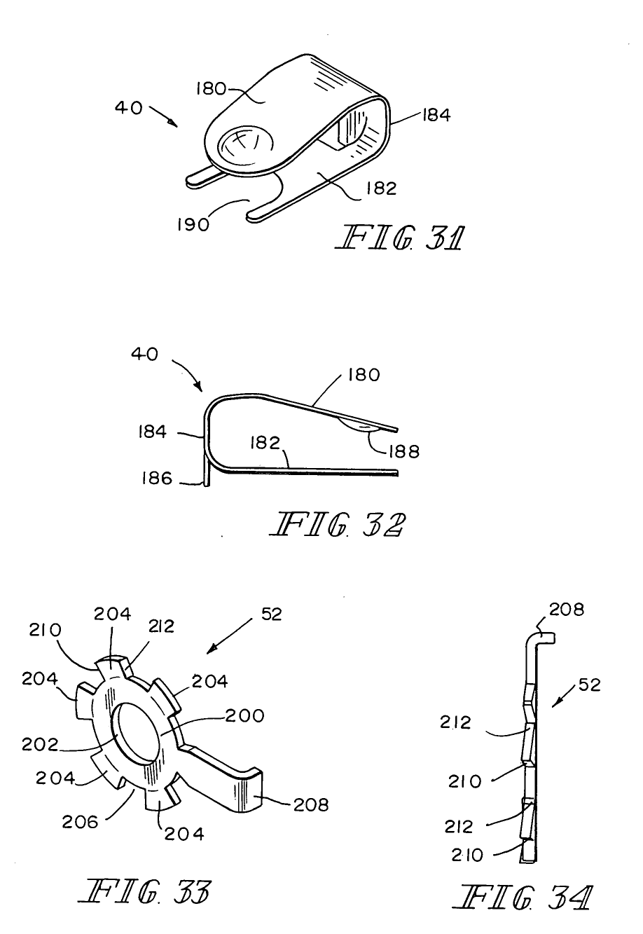

Referring to FIGS. 31 and 32, the snap spring 40 a first arm portion 180 and a second arm portion 182, and a mid-section 184 interconnecting the first and second arm portions 180, 182 and including an outwardly-extending positioning tab 186. The positioning tab 186 is received in the positioning hole 84 in the front support plate 48 to maintain the orientation of the snap spring 40 relative to the front support plate 50 during operation of the locking mechanism. The first portion 180 includes an inverted dome-shaped portion 188 adapted to press the locking bar 38 against the lifting cam 46. The second portion 182 includes a cutout 190 configured to receive the drive shaft 44.

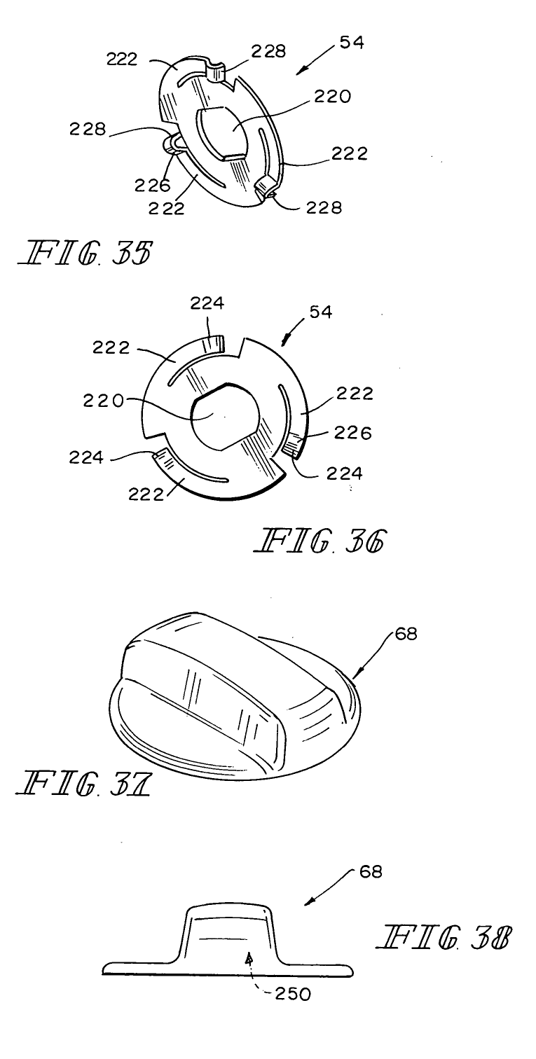

Locking plate 52 is mounted on the rear support plate 50 as shown in FIGS. 33 and 34, and detent plate 54 is mounted on the drive shaft 44 for rotation therewith as shown in FIG. 35. The locking plate 52 and the detent plate 54 cooperate to allow only clockwise rotation of the drive shaft 44 and the lifting cam 46 coupled thereto. Again as indicated above, unless specified otherwise, all rotational directions (clockwise or anticlockwise) are referenced from the end 26 of the assembly 30 having the knob 68. The locking plate 52 and the detent plate 54 also serve to provide an auditory and tactile feedback to the user every time the drive shaft 44 is rotated 60° in the clockwise direction.

As shown in FIGS. 33 and 34, the locking plate 52 includes an annular portion 200 having a central bore 202 configured to rotatably receive the drive shaft 44 and six segments 204 which extend radially outwardly from the annular portion 200. The drive shaft 44 is freely rotatable in the bore 202. The six segments 204 are separated by six cutouts 206. Each of the six segments and six cutouts 204, 206 forms a 30° angle at the center of the annular portion 200. One of the segments 204 extends radially outwardly and is formed to include a positioning tab 208 at one end thereof which extends perpendicularly from the plane of the locking plate 52 as shown. The positioning tab 208 is received in the positioning hole 84 in the rear support plate 50 to maintain the orientation of the locking plate 52 relative to the rear support plate 50. Each segment 204 has a leading edge 210 and a trailing edge 212. The leading edge 210 of each segment is slightly depressed below the plane of the locking plate 52 and the trailing edge 212 is slightly raised above the plane of the locking plate 52 to facilitate clockwise rotation of the drive shaft 44 and to block anticlockwise rotation of the drive shaft 44.

Referring to FIGS. 35 and 36, the detent plate 54 has a double-D bore 220 at the center for receiving the double-D portion 132 of the drive shaft 44 so that the drive shaft 44 and the detent plate 54 are rotatably coupled to each other. The detent plate 54 further includes three peripheral arcuate segment 222. The terminal portion of each segment 222 is formed to include a generally V-shaped detent or catch 224 which has a portion extending below the plane of the detent plate 54. Each V-shaped detent 224 has an inclined leading edge 226 and a trailing edge 228 arranged to lie perpendicular to the plane of the detent plate 54. The three perpendicular trailing edges 228 are spaced 120° apart as shown. When the drive shaft 44 is rotated clockwise, the inclined leading edges 226 of the detent plate 54 ride up the depressed leading edges 210 of the locking plate 52 to allow clockwise rotation of the drive shaft 44. On the other hand, the perpendicular trailing edges 228 of the detent plate 54 are blocked by the raised trailing edges 212 of the locking plate 52 to prevent anticlockwise rotation of the drive shaft 44.

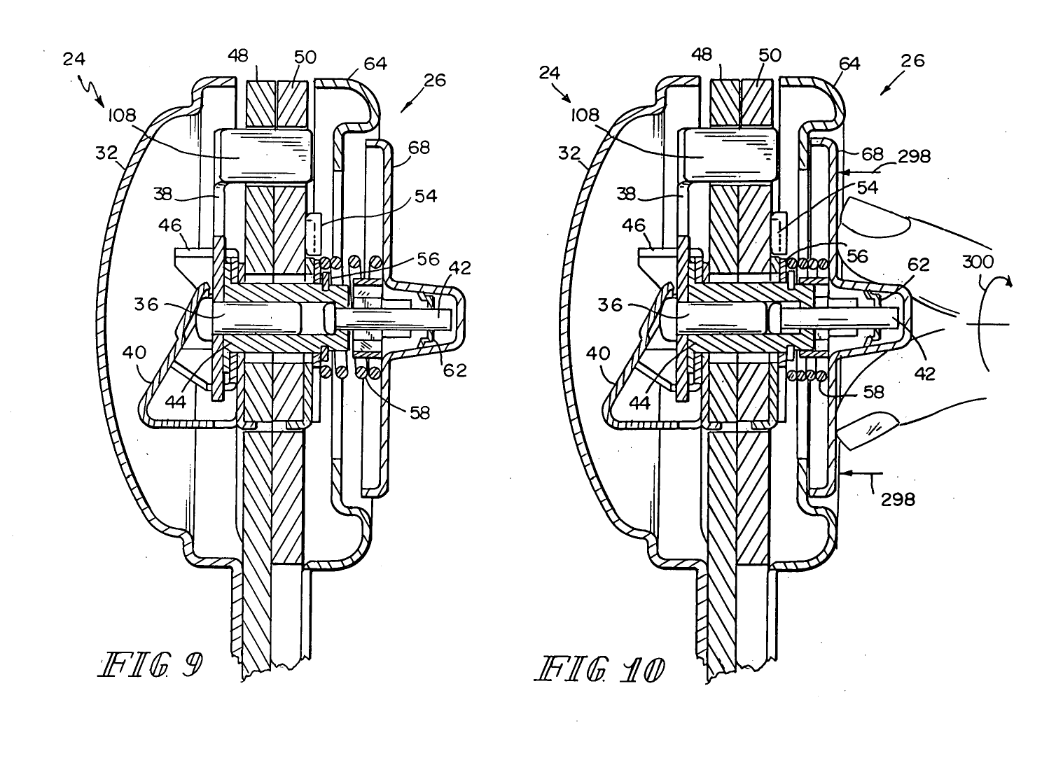

The assembly of various components will now be explained with reference to FIGS. 8-12. The drive shaft 44 is inserted into the bore 142 of the lifting cam 46 so that the head portion 120 of the drive shaft 44 engages the annular portion 140 of the lifting cam 46 and the double-D portion 132 of the drive shaft 44 engages the double-D bore 142 in the lifting cam 46 as shown, for example, in FIG. 9. The knob support pin 42 is inserted into the counterbore 128 of the drive shaft 44 so that the head portion 170 of the knob support pin 42 engages the annular seat portion 130 of the drive shaft 44. The locking bar support pin 36 is inserted through the central bore 102 in the locking bar 38, and then inserted into the bore 126 in the drive shaft 44. The snap spring 40 is then installed so that the first and second arm portions 180, 182 of the snap spring 40 straddle the locking bar 38 and the lifting cam 46, and the drive shaft 44 is received in the U-shaped cutout 190 in the snap spring 40 as shown, for example, in FIG. 9. The positioning tab 186 of the snap spring 40 engages the positioning hole 84 in the front support plate 48 to maintain the orientation of the snap spring 40 relative to the front support plate 48 during operation of the locking assembly. The snap spring 40 biases the locking bar 38 against the lifting cam 46. The snap spring 40 also serves to retain the locking assembly comprising the locking bar 38, lifting cam 46 and the two support pins 36, 42 together as a unit. The snap spring 40 is relatively stiff in order to ensure that the locking tabs 108, 110 snap into the locking slots 78 or 80 in the rear support plate 50 (depending on whether the ladder 20 is in the 0° or 180° configuration or in the 40° configuration) when they are aligned with the locking slots 76 in the front support plate 48. The lifting cam 46 is designed to rotate only in the clockwise direction to alternately raise and lower the locking bar 38 with each 60° rotation of the lifting cam 46 in the clockwise direction.

The drive shaft 44 is then passed through the central bores 74 in the support plates 48, 50 so that the rearwardly facing surface of the lifting cam 46 seats against the forwardly-facing surface of the front support plate 48 and the rearwardly-facing surface of the front support plate 48 seats against the forwardly-facing surface of the rear support plate 50 as shown in FIGS. 9-12. The locking plate 52 is installed so that the drive shaft 44 extends through the central bore 202 in the locking plate 52 and the positioning tab 208 of the locking plate 52 engages the positioning hole 84 in the rear support plate 50 to maintain the orientation of the locking plate 52 relative to the rear support plate 50 during operation of the locking assembly. The drive shaft 44 is then inserted through the double-D bore 220 in the detent plate 54 so that the double-D portion 132 of the drive shaft 44 engages the double-D bore 220 in the detent plate 54 to rotatably couple the detent plate 54 to the drive shaft 44. The spring clip 56 is then installed in the locking groove 136 in the drive shaft 44 to retain the assembly together as a unit.

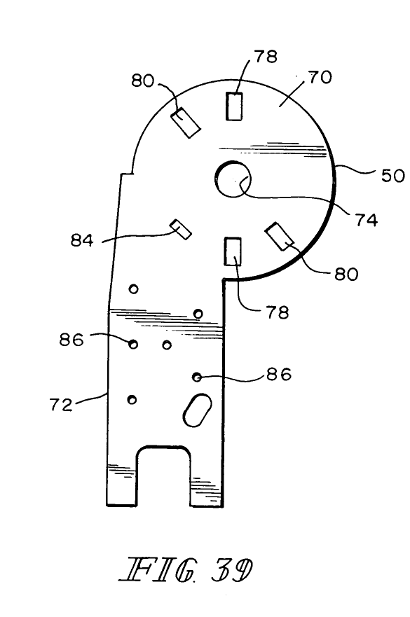

The drive shaft 44 is then passed through the knob spring 58 and the winged hex drive 60 so that the knob support pin 42, which is inserted through the counterbore 128 in the drive shaft 44 and seated against the annular seat portion 130 in the drive shaft 44, extends through the knob spring 58 and the winged hex drive 60. The lock washer 62 is inserted in the locking groove 174 in the knob support pin 42. The knob 68 is then installed so that the tabs 240 of the hex drive 60 and the lock washer 62 are received in the tab-receiving slot 250 in the knob 68 (see FIGS. 37, 38) to attach the knob 68 to the drive shaft 44 securely. The front and rear outer covers 32, 34, 64, 66 are then installed. The outer covers 32, 34, 64, 66 serve to provide a rotational stop to prevent rotation of the legs 22 beyond the 180° or extension ladder configuration; to shield the assembly 30 from dirt and debris; and to prevent foreign objects from being inadvertently inserted therein.

As indicated previously, the knob 68 must be first pushed inward against the knob spring 58 in a direction 298 in FIG. 10 to cause the hex drive 60 to engage the hex drive portion 136 of the drive shaft 44 before the knob 68 can be rotated in a clockwise direction 300 to, in turn, rotate the drive shaft 44 and the lifting cam 46 also in the clockwise direction 300 to lift the locking bar 38 away from the support plates 48, 50. The knob spring 58 is relatively weak to reduce the force required to push the knob 68 inward to engage the hex drive portion 136 of the drive shaft 44. FIGS. 9-11 show the sequence of pushing the knob 68 inward and then turning it through 60° in the clockwise direction 300. Lifting the locking bar 38 away from the support plates.48, 50 withdraws the locking tabs 108, 110 out of the locking slots 78, 80 in the rear support plate 50 (as shown, for example, in FIG. 11) to unlock the locking assembly 30 to permit relative movement of the support plates 48, 50 relative to each other.

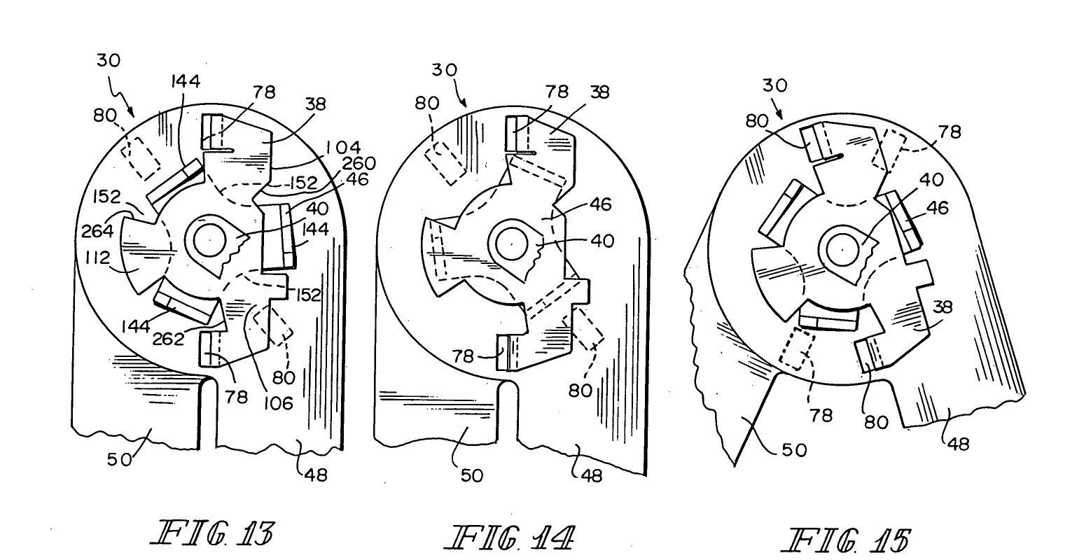

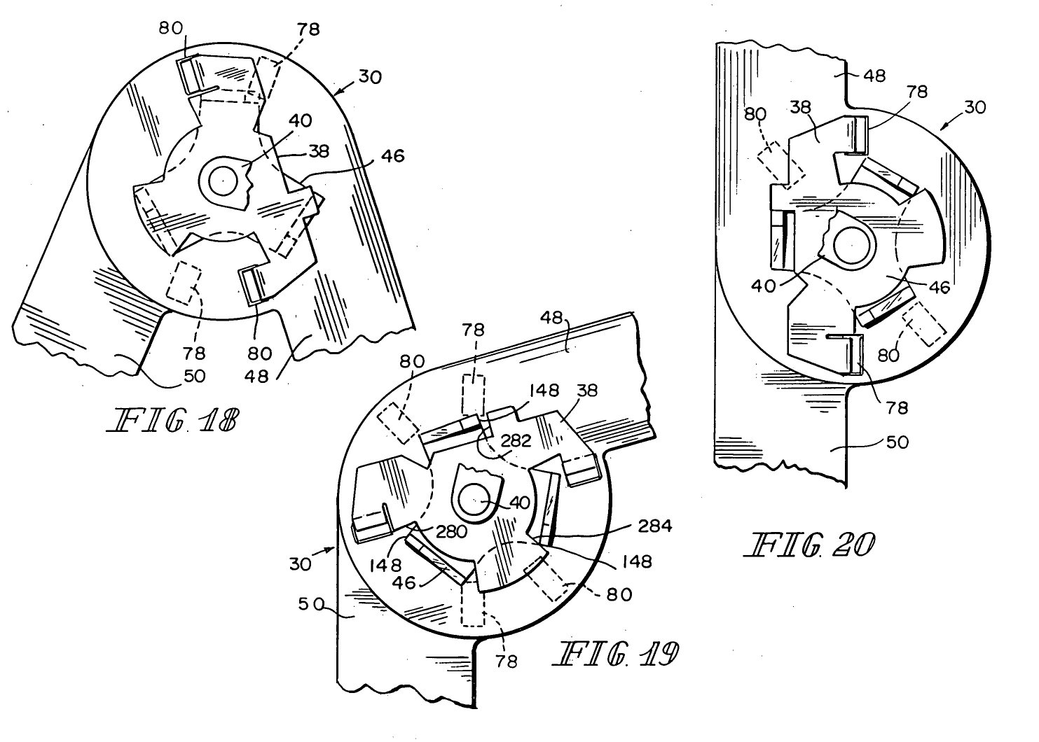

FIGS. 13-23 show relative positions of the locking bar 38 and the lifting cam 46 as the ladder 20 is cycled between the collapsed configuration shown in FIG. 2, the step ladder configuration shown in FIG. 3, and the extension ladder configuration shown in FIG. 4. When the ladder 20 is locked in any one of the three configurations shown in FIGS. 2-4, the two straight portions 104, 106 and the truncated pie-shaped portion 112 are arranged to lie in the three cutouts 152 between the three lobes 144 of the lifting cam 46 as shown, for example, in FIG. 13 (the collapsed configuration), FIG. 15 (the step ladder configuration) and FIG. 20 (the extension ladder configuration). This allows the snap spring 40 to drive the locking bar 38 against the annular base portion 140 of the lifting cam 46 to, in turn, drive the tabs 108, 110 of the locking bar 38 through the aligned slots 76 in the front support plate 48 and the slots 78 or 80 in the rear support plate 50 (depending on whether the ladder 20 is in the 0° or 180° configuration or in the 40° configuration) as shown, for example, in FIG. 9 to lock the assembly 30 to, in turn, block relative movement of the support plates 48, 50 relative to each other.

To unlock, the knob 68 is pushed in as shown in FIG. 10 and rotated 60° in the clockwise direction as shown in FIG. 11. This, in turn, causes the drive shaft 44 and the lifting cam 46 to rotate 60° in the clockwise direction. As the lifting cam 46 rotates, the inclined leading edges 146 of the lifting cam 46 engage the respective leading edges 260, 262, 264 of the outwardly-extending portions 104, 106 and 112 of the locking bar 38 (see FIG. 24) to lift the locking bar 38 away from the support plates 48, 50 against the force of the snap spring 40 as shown in FIG. 11. Lifting the locking bar 38 away from the support plates 48, 50 withdraws the locking tabs 108, 110 out of the locking slots 78 or 80 in the rear support plate 50 (depending on whether the ladder 20 is in the 0° or 180° configuration or in the 40° configuration) to unlock the locking assembly 30 to, in turn, permit relative movement of the support plates 48, 50 relative to each other. While the tabs 108, 110 are withdrawn from the slots 78 or 80 in the rear support plate 50 when the locking bar 38 is lifted, the tabs 108, 110 remain extended into the slots 76 in the front support plate 48. Thus, the locking tabs 108, 110 always remain extended into the slots 76.

FIGS. 13-15 show relative positions of the locking bar 38 and the lifting cam 46 as the ladder 20 moves from the collapsed or 0° configuration shown in FIG. 2 to the step ladder or 40° configuration shown in FIG. 3. In the collapsed configuration of the ladder 20 shown in FIG. 13, the locking tabs 108, 110 are driven through the slots 78 in the rear support plate 50 as shown, for example, in FIG. 9. The assembly 30 is first unlocked by pushing the knob 68 inward and turning it through 60° in the clockwise direction as shown in FIG. 14. The legs 22 of the ladder 20 are then spread apart. When the ladder 20 arrives at the step ladder configuration shown in FIG. 15, the locking tabs 108, 110 are driven through the slots 80 in the rear support plate 50 to lock the assembly 30.

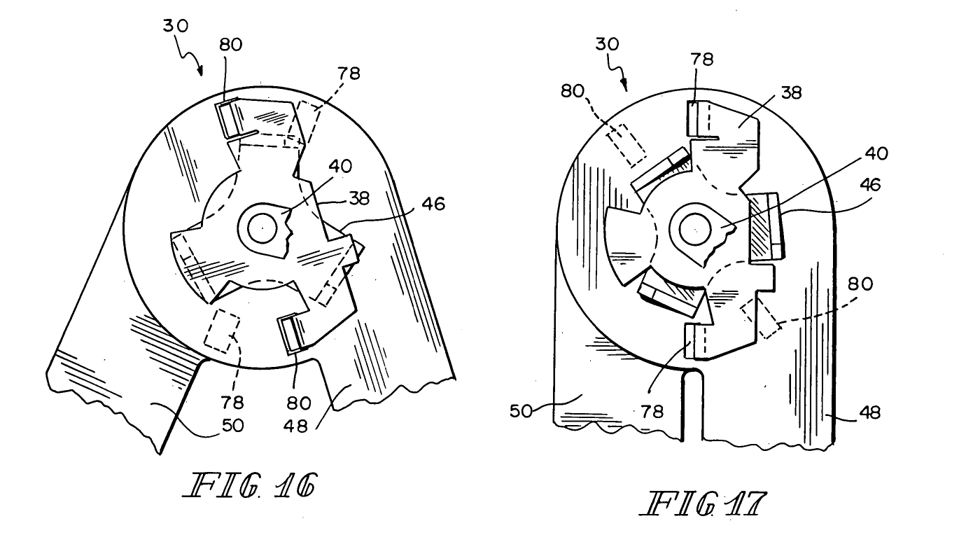

FIGS. 16, 17 show relative positions of the locking bar 38 and the lifting cam 46 as the ladder 20 moves back to the collapsed configuration shown in FIG. 2. The locking assembly 30 is first unlocked by pushing the knob 68 inward and turning it through 60° in the clockwise direction as shown in FIG. 16. The legs 22 of the ladder 20 are then brought together. When the ladder 20 arrives at the collapsed configuration shown in FIG. 17, the locking tabs 108, 110 are driven through the slots 78 in the rear support plate 50 to lock the assembly 30.

FIGS. 15 and 18-20 show relative positions of the locking bar 38 and the lifting cam 46 as the ladder 20 moves from the step ladder configuration shown in FIG. 3 to the extension ladder configuration shown in FIG. 4. In the step ladder configuration of the ladder 20 shown in FIG. 15, the locking tabs 108, 110 extend through the slots 80 in the rear support plate 50. The assembly 30 is first unlocked by pushing the knob 68 inward and turning it through 60° in the clockwise direction as shown in FIG. 18. The legs 22 of the ladder 20 are then spread apart. When the legs 22 are about 120° apart as shown in FIG. 6, the locking bar 38 moves off the lifting cam 46 as shown in FIG. 12 into the areas occupied by the cutouts 152 in the lifting cam 46 as shown in FIG. 19. This allows the locking bar 38 to drop down a distance 270 in FIG. 11, where the locking tabs 108, 110 ride on the forwardly-facing surface of the rear support plate 50 and the trailing edges 280, 282, 284 of the locking bar 38 (see FIG. 24) engage the perpendicular edges 148 of the lifting cam 46 as shown in FIG. 19. As the legs 22 continue to move to the extension ladder configuration, the locking bar 38 drives the lifting cam 46 through about 60° in the clockwise direction as shown in FIGS. 19, 20 (or in the anticlockwise direction as viewed from the end 24 of the assembly 30 having the lifting cam 46). When the ladder 20 arrives at the extension ladder configuration shown in FIG. 20, the locking tabs 108, 110 are driven through the slots 78 in the rear support plate 50 to lock the assembly 30.

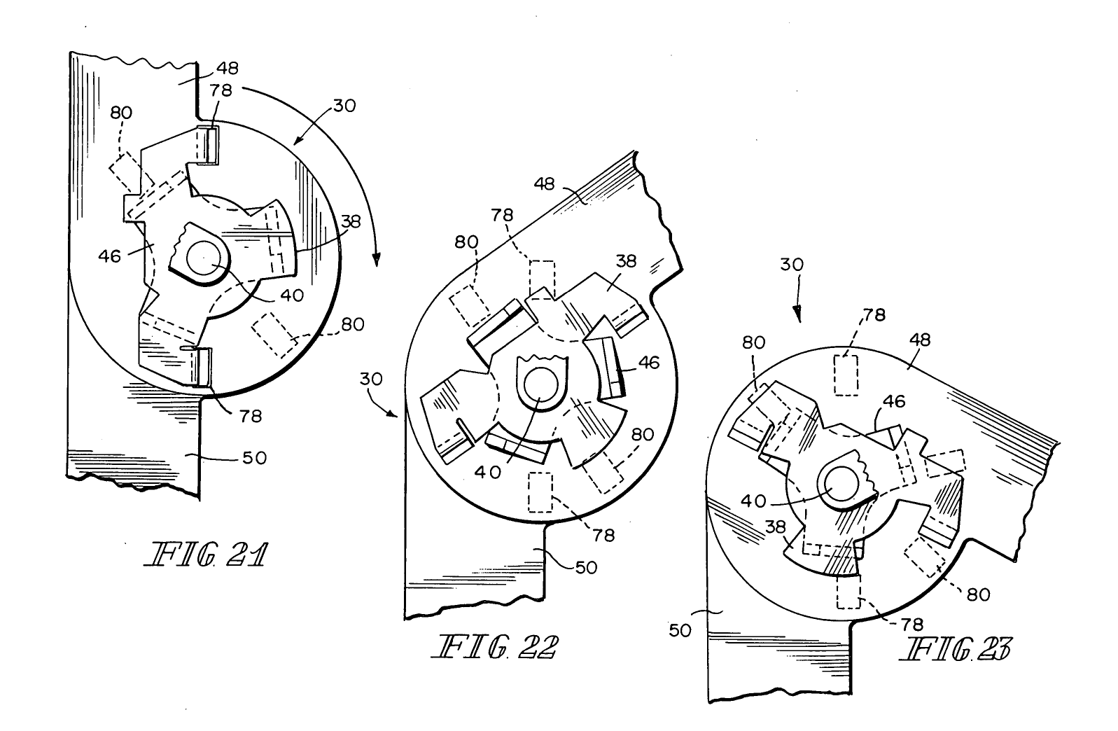

FIGS. 20-23 show relative positions of the locking bar 38 and the lifting cam 46 as the ladder 20 moves from the extension ladder configuration shown in FIG. 4 to the collapsed configuration shown in FIG. 2. The assembly 30 is first unlocked by pushing the knob 68 inward and turning it through 60° in the clockwise direction as shown in FIGS. 20, 21. The legs 22 of the ladder 20 are then brought together. When the legs 22 are about 40° apart corresponding to the step ladder configuration shown in FIG. 3, the locking bar 38 is on top of the lifting cam 46 as shown in FIG. 22. This prevents the snap spring 40 from driving the locking bar 38 toward the support plates 48, 50 to, in turn, lock the assembly 30. Thus, the ladder 20 passes through the step ladder configuration shown in FIG. 3 without locking the assembly 30. As the legs 22 arrive at the collapsed configuration in FIG. 23, the locking tabs 108, 110 are driven through the slots 78 in the rear support plate 50 to lock the assembly 30.

1. A hinge and locking assembly comprising
a pair of support members rotatable relative to each other about a common axis, each support member having at least one locking slot,
a lock having at least one locking tab configured for receipt in the locking slots in the support members to block relative movement of the support members relative to each other, and
a lifting cam configured to move the lock relative to the support members to selectively disengage the locking tab from the locking slots in the support members to permit relative movement of the support members relative to each other.

2. The hinge and locking assembly of claim 1, wherein the lock is rotatable about the common axis.

3. The hinge and locking assembly of claim 1, wherein the lifting cam is rotatable about the common axis.

4. The hinge and locking assembly of claim 1, wherein both the lock and the lifting cam are rotatable about the common axis.

5. The hinge and locking assembly of claim 4, further including a drive shaft rotatable about the common axis, wherein the lifting cam is coupled to the drive shaft for rotation therewith.

6. The hinge and locking assembly of claim 5, wherein the lock is coupled to the drive shaft for axial movement toward and away from the support members.

7. The hinge and locking assembly of claim 6, wherein the lock has a pair of axially-extending locking tabs which are spaced at equal radial distances from the common axis on the opposite sides thereof along a line that extends through the common axis.

8. The hinge and locking assembly of claim 7, wherein a first one of the support members has a pair of axially-extending locking slots which are spaced at equal radial distances from the common axis on the opposite sides thereof along a line that extends through the common axis, and wherein a second one of the support members has a first pair of axially-extending locking slots which are spaced at equal radial distances from the common axis on the opposite sides thereof along a line that extends through the common axis so that the locking tabs of the lock can extend through the pair of locking slots in the first support member and the first pair of locking slots in the second support member in a first configuration of the support members.

9. The hinge and locking assembly of claim 8, wherein the second support member has a second pair of axially-extending locking slots which are spaced at equal radial distances from the common axis on the opposite sides thereof along a line that extends through the common axis so that the locking tabs of the lock can extend through the pair of locking slots in the first support member and the second pair of locking slots in the second support member in a second configuration of the support members.

10. The hinge and locking assembly of claim 9, wherein the first and second pairs of axially-extending locking slots in the second support member are arranged to form an acute angle relative to each other.

11. The hinge and locking assembly of claim 9, further including a spring for biasing the lock toward the support members to urge the locking tabs to extend through the locking slots in the support members.

12. The hinge and locking assembly of claim 9, wherein the locking tabs of the lock extend through the first pair of locking slots in the second support member in a collapsed configuration of the support members.

13. The hinge and locking assembly of claim 12, wherein the locking tabs of the lock extend through the first pair of locking slots in the second support member in an extension ladder configuration of the support members in addition to the collapsed configuration of the support members.

14. The hinge and locking assembly of claim 9, wherein the locking tabs of the lock extend through the second pair of locking slots in the second support member in a step ladder configuration of the support members.

15. The hinge and locking assembly of claim 9, further including a knob configured to be coupled to the drive shaft to cause rotation of the drive shaft.

16. The hinge and locking assembly of claim 9, wherein lifting cam has three lobes and three cutouts between the lobes, and wherein each lobe and each cutout forms a 60° angle at the common axis so that the lifting cam alternately moves the lock toward and away from the support members with each 60° rotation thereof.

17. The hinge and locking assembly of claim 16, further including a counter rotation locking mechanism to allow rotation of the drive shaft about the common axis only in a first direction, and to block rotation of the drive shaft about the common axis in a second opposite direction.

18. The hinge and locking assembly of claim 17, wherein the counter rotation locking mechanism includes a locking member coupled to one of the support members for rotation therewith and a detent member coupled to the drive shaft for rotation therewith.

19. The hinge and locking assembly of claim 18, wherein the locking member has six tabs and six cutouts between the tabs, and wherein each tab and each cutout in the locking member forms a 30° angle at the common axis.

20. The hinge and locking assembly of claim 19, wherein the detent member has three peripheral detents spaced 120° apart.

21. The hinge and locking assembly of claim 9, wherein the locking slots are radially extending.

22. The hinge and locking assembly of claim 9, wherein the locking slots are peripherally spaced.

23. The hinge and locking assembly of claim 9, wherein the locking slots are rectangular.

24. The hinge and locking assembly of claim 9, wherein the locking slots are square.

25. The hinge and locking assembly of claim 9, wherein the locking slots are circular.

26. The hinge and locking assembly of claim 13, further including front and rear outer covers configured to prevent rotation of the support members beyond the extension ladder configuration.

27. A locking hinge apparatus comprising
first and second hinge members coupled together for rotation about an axis,
a lock movable between a locking position in which the first and second hinge members are prevented from rotating about the axis and a releasing position in which the first and second hinge members are permitted to rotate about the axis, and
a knob rotatable about the axis and movable along the axis, the lock moving from the locking position to the releasing position in response to movement of the knob axially toward the first and second hinge members and then rotation of the knob about the axis.

28. The locking hinge apparatus of claim 27, wherein the lock is movable axially along the axis relative to the hinge members between the locking and releasing positions.

29. The locking hinge apparatus of claim 28, comprising a lifting cam configured to move the lock between the locking and releasing positions.

30. The locking hinge apparatus of claim 29, wherein the lifting cam is rotatable about the axis.

31. The locking hinge apparatus of claim 30, comprising a drive shaft rotatable about the axis, wherein the first and second hinge members and the lock are rotatably mounted on the drive shaft, and wherein the lifting cam and the knob are mounted on the drive shaft for rotation therewith.

32. The locking hinge apparatus of claim 31, wherein each hinge member has at least one locking slot, and wherein the lock has at least one locking tab configured for receipt in the locking slots in the hinge members to block relative movement of the hinge members relative to each other.

33. The locking hinge apparatus of claim 32, further comprising a locking member coupled to one of the hinge members for rotation therewith and a detent member coupled to the drive shaft for rotation therewith, wherein the locking and detent members cooperate with each other to allow rotation of the drive shaft in a first direction, and to block rotation of the drive shaft in a second opposite direction.

34. A locking hinge apparatus comprising
first and second hinge members coupled together for rotation about an axis,
a lock movable between a locking position in which the hinge members are prevented from rotating about the axis and a releasing position in which the hinge members are permitted to rotate about the axis, and
means for moving the lock from the locking position to the releasing position.

35. The locking hinge apparatus of claim 34, wherein the moving means comprises a knob rotatable about the axis and movable along the axis, the lock moving from the locking position to the releasing position in response to movement of the knob axially toward the hinge members and then rotation of the knob about the axis.

36. The locking hinge apparatus of claim 35, further comprising a cam rotatable about the axis in response to rotation of the knob about the axis to move the lock between the locking and releasing positions.

37. The locking hinge apparatus of claim 35, wherein the lock is movable axially along the axis from the locking position to an intermediate position in response to axial movement of the knob toward the hinge members.

38. The locking hinge apparatus of claim 37, further comprising a lock support pin movable axially along the axis in response to axial movement of the knob, wherein the lock is mounted on the lock support pin for axial movement therewith so that the lock moves from the locking position to the intermediate position in response to axial movement of the knob toward the hinge members.

39. The locking hinge apparatus of claim 37, further comprising a cam rotatable about the axis in response to rotation of the knob about the axis, wherein the cam is prevented from rotating about the axis when the lock is in the locking position and the cam is permitted to rotate about the axis when the lock is in the intermediate position.

40. The locking hinge apparatus of claim 39, wherein the lock moves from the locking position to the intermediate position in response to axial movement of the knob toward the hinge members, and the lock moves from the intermediate position to the releasing position in response to rotation of the knob about the axis.

41. The locking hinge apparatus of claim 40, further comprising a drive shaft rotatable about the axis, wherein the hinge members and the lock are rotatably mounted on the drive shaft, and wherein the cam and the knob are mounted on the drive shaft for rotation therewith.

42. The locking hinge apparatus of claim 41, wherein each hinge member has at least one locking slot, and wherein the lock has at least one locking tab configured for receipt in the locking slots in the hinge members to block relative movement of the hinge members relative to each other.

43. The locking hinge apparatus of claim 42, further comprising a locking member coupled to one of the hinge members for rotation therewith and a detent member coupled to the drive shaft for rotation therewith, wherein the locking and detent members cooperate with each other to allow rotation of the drive shaft in a first direction, and to block rotation of the drive shaft in a second opposite direction.
